(19) United States
(12) Patent Application Publication
(10) Pub. No.: US 2006/0114691 A1
(43) Pub. Date: Jun. 1, 2006

(54) Backlight device, liquid crystal display and method of lighting a liquid crystal display

(76) Inventors: Wanda Susanne Kruijt, Eindhoven (NL); Franciscus Johannes Stommels, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/524,179

(22) PCT Filed: Jul. 17, 2003
(86) PCT No.: PCT/IB03/03267

§ 371 Date: Feb. 10, 2005

(30) Foreign Application Priority Data
Aug. 15, 2002 (EP) 02078380.9

(51) Int. Cl. F21V 7/04

(52) U.S. Cl. 362/614

(57) ABSTRACT

A backlight device for a liquid crystal display (13) comprises several lamps (1) disposed within a housing (20). Each lamp (1) comprises a part that can be cooled so as to obtain a good light output. The said parts of the lamps (1) extend through the wall (18) of the housing (20) into a channel (21) through which air can flow. The lamps (1) are tube-like fluorescent lamps, which extend into the channel (21) with at least one end.

The invention relates to a backlight device, in particular for a liquid crystal display, which comprises several lamps disposed within a housing, whereby each lamp comprises a part that can be cooled so as to obtain a good light output. In particular, said lamps are fluorescent lamps having so-called cold spots that form spaces in which mercury can condense. An optimum light output is obtained if the temperature of the cold spots is kept within predetermined bounds.

A liquid crystal display comprises a crystal display matrix containing a liquid crystalline material. The light transmission of the crystalline material is determined by the orientation of the liquid crystalline material, which orientation is adjusted by applying a voltage across the material. The liquid crystalline material itself does not give light. The image that is shown on the crystal display matrix is produced by a backlight device which is arranged behind the matrix, in which backlight device one or more tube-like fluorescent lamps are present. The light from the lamps shines through the crystalline material, and the local differences in the orientation of the crystalline material result in the image that can be seen.

On the one hand it is important for the lamps to have an optimum light output, whilst on the other hand it is important that as much of the light as possible shines in the direction of the crystal display, and that in such a manner that the light is evenly distributed over the entire area of the crystal display matrix.

The light output of fluorescent lamps can be optimized by keeping the temperature of particular parts of the lamps within predetermined bounds. It is known to cool said parts for that purpose, for example by placing said parts into contact with a heat-conducting material capable of dissipating the excess heat. It is also known to obtain a cooling effect by placing the lamp in an air flow, which air flow can be generated by means of a fan.

The cooling of the backlight lamps by means of an air flow is disclosed in WO-A-99/43014. Air is blown in the direction of the lamps therein by means of one or more fans when the temperature of the lamps as measured by a sensor becomes too high. This method of cooling the lamps is not very efficient, because also parts of the lamp whose temperature does not affect the light output are cooled. In addition, this manner of cooling leads to fouling of the lamps and of the space in which the lamps are disposed, because the air flow carries dust and other impurities along into the space in which the lamps are disposed. Said fouling can be prevented by passing the air through a filter, but this requires additional energy, whilst furthermore the filter needs to be cleaned from time to time.

The object of the invention is to provide a backlight device in which said cooling of the lamps takes place in an efficient manner.

In order to accomplish that objective, the aforesaid parts of the lamps extend through the wall of the housing into a channel through which air can flow, which air cools the parts in question when their temperature rises too high. The space in which the larger part of each lamp is present, which space is formed by the aforesaid housing and by the rear side of the crystal display matrix or by a diffuser plate disposed between the backlight lamps and the crystal display matrix, may be airtight or dust-tight in that case, so that said space will remain free from impurities.

Preferably, said lamps are tube-like fluorescent lamps, which extend into the channel with at least one end, in which end the cold spot is present. The temperature of this part of the lamp can thus be kept within the desired bounds in an efficient manner.

In one preferred embodiment, a fan is present for generating an air flow through the channel, which fan preferably extracts air from the channel, or blows air into the channel, as the case may be, at a location between two of the aforesaid lamp parts. Thus, the two aforesaid lamp parts are cooled to the same extent, because the air does not pass said two parts in succession in that case.

Preferably, a sensor is present for measuring the temperature of the part of a lamp that extends into the channel, so that the operation of the fan can be controlled in dependence on said temperature.

In one preferred embodiment, the channel comprises a wall which is provided with a recess between two of the aforesaid lamp parts so as to allow air to pass therethrough. In particular when air is extracted from the channel by the fan or the fans, an even cooling of the various lamps can be achieved by providing the wall of the channel with recesses (openings into the outside air) at suitable locations, in particular between two of the aforesaid lamp parts, in which cooled air enters the channel at the location of a recess. It is possible thereby to prevent a situation in which said cooling takes place by air that flows past all of the aforesaid parts in succession, which would lead to a reduced cooling effect in downstream direction as a result of said air being heated. The heated air can be mixed with fresh, cool air in downstream direction.

In one preferred embodiment, the housing of the lamps forms a dustproof space, and the aforesaid wall abuts against the lamp in a substantially dust-tight manner at the location where the lamp extends through said wall. Preferably, said wall abuts against the glass, light-transmitting part of the lamp in a substantially dust-tight manner. The end of the tube-like lamp, on which a metal cap may be present, extends outside the dustproof space in that case, and the seal surrounding the lamp may be formed by a circular hole in the wall of the housing.

Preferably, the aforesaid wall comprises a flexible material which abuts against the lamp, which flexible material is preferably a synthetic foam material capable of proper abutment against the glass of the lamp.

In one preferred embodiment, the aforesaid wall comprises two parallel plates, preferably made of metal, between which the flexible material is arranged. The lamp extends through a recess in each of the two plates and through a corresponding recess in the flexible material in that case. The recesses in each of the metal plates may be larger than the recess in the flexible material, the dimension of which latter recess may be slightly smaller than the cross-sectional dimension of the lamp, so that a proper abutment of the material against the lamp is obtained.

Preferably, the housing abuts against a diffuser plate, so that the housing and the diffuser plate together form the dustproof space.

The invention furthermore relates to a liquid crystal display comprising a backlight device as described above.

The invention also relates to a method of lighting a liquid crystal display, which display includes a backlight device which comprises several lamps disposed within a housing, whereby each lamp comprises a part that can be cooled so as to obtain a good light output, and whereby the aforesaid parts of the lamps extend through the wall of the housing into a channel through which air flows.

The invention will be explained in more detail hereinafter by means of a description of an embodiment of a liquid crystal display, in which reference is made to a drawing, in which:

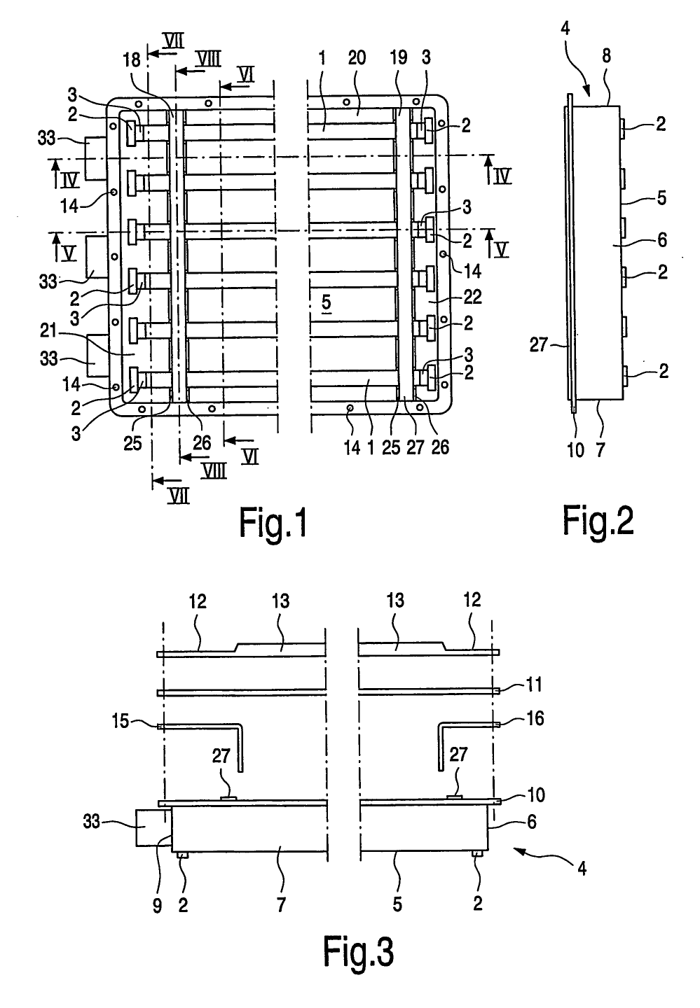

FIG. 1 is a front view of backlight lamps in a light box;

FIG. 2 is a side elevation of said light box;

FIG. 3 is a side elevation of the light box, showing a diffuser plate and a frame with a crystal display matrix disposed above said light box;

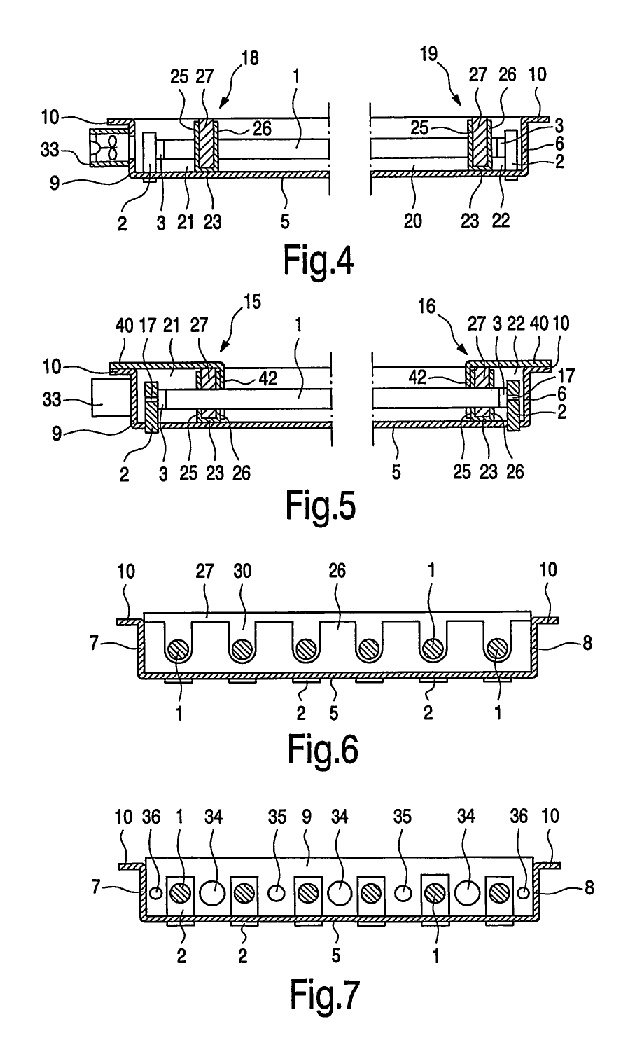

FIG. 4 is a sectional view along the line IV-IV in FIG. 1;

FIG. 5 is a sectional view along the line V-V in FIG. 1, in which cover plates are shown as well;

FIG. 6 is a sectional view along the line VI-VI in FIG. 1;

FIG. 7 is a sectional view along the line VII-VII in FIG. 1;

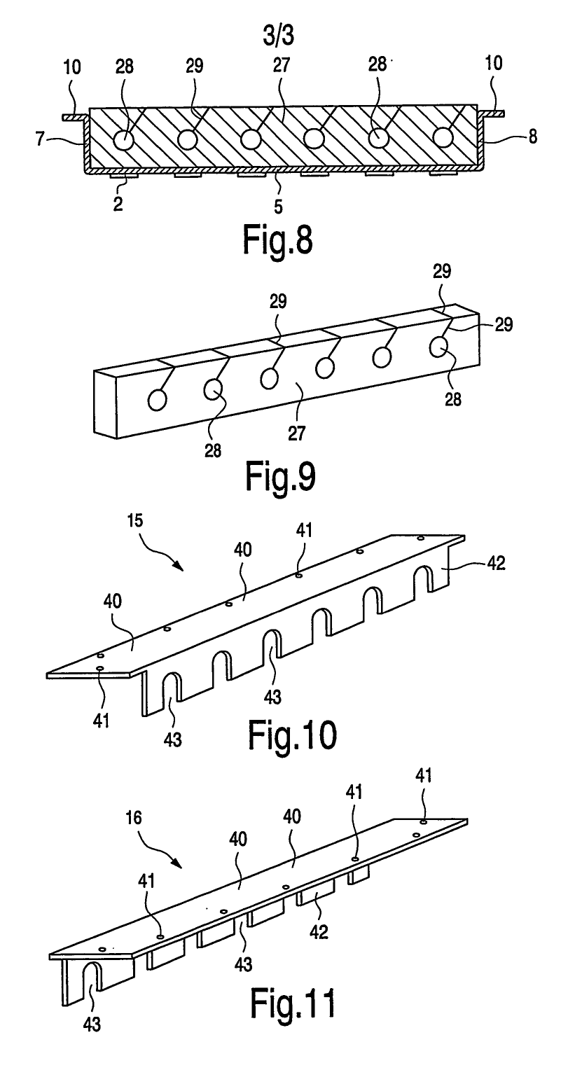

FIG. 8 is a sectional view along the line VIII-VIII in FIG. 1;

FIG. 9 is a perspective view of a piece of foam material;

FIG. 10 is a perspective view of a cover plate; and

FIG. 11 is a perspective view of another cover plate.

The figures are merely schematic representations of the embodiment, in which less relevant parts are not shown.

FIG. 1 shows six straight, mutually parallel tube-like fluorescent lamps 1, which are mounted in fittings 2 at their ends. The ends of the lamps 1, which are provided with a metal cap 3, extend into the fittings 2 with a pin 17 (see FIG. 5). The fittings 2 are mounted in a light box 4, which comprises a rear wall 5 and four side walls 6,7,8,9. The light box 4 is circumferentially provided with a flange 10 at its front side. The light box 4 that is shown in FIG. 1, together with the parts that are mounted thereon, is called a backlight device.

The fittings 2 are mounted on the rear wall 5 of the light box 4, extending through recesses in said rear wall to a position beyond the rear wall 5, at which position they are connected to electrical conducting wires (not shown) for supplying current.

FIG. 2 is a side elevation of the light box 4, showing the parts of the fittings 2 that project behind the light box. FIG. 3 is a side elevation of the light box 4 in another direction, in which the projecting parts of the fittings 2 are also shown.

In FIG. 3, two cover plates 15,16 as well as a diffuser plate 11 and a frame 12, in which a crystal display matrix 13 is arranged, are shown above the light box 4. In the assembled condition of the liquid crystal display, the cover plates 15,16, the diffuser plate 11 and the frame 12 are fixed to the flange 10 of the light box 4. Bolts may extend through the holes 14 (see FIG. 1) in the flange 10 to that end, and filling pieces and a sealing material may be used so as to obtain a proper abutment.

The diffuser plate 11 contributes to an even distribution of the light from the light box 4, so that the rear side of the crystal display matrix 13 is uniformly lighted. This results in an image on the front side of the crystal display matrix 13 that is determined by the orientation of the liquid crystals. Since the invention is concerned with the backlight of the display, the operation of the crystal display matrix 13 will not be discussed in more detail herein.

Two walls 18, 19 divide the light box 4 into a space 20 disposed behind the crystal display matrix 13, a channel 21 covered by the cover plate 15, and a space 22 covered by the cover plate 16. FIGS. 4 and 5 show the walls 18,19 in cross-sectional view, and FIG. 5 shows the cover plates 15,16. The lamps 1 are present in the space 20 for the larger part, each lamp 1 extending through the wall 18 into the channel 21 with one end and through the wall 19 into the space 22 with the other end. The space 20 is called the housing of the lamps 1.

As is shown in FIGS. 4 and 5, the wall 18,19 comprises a bent metal plate of U-shaped cross-section, the base 23 of which is attached to the rear wall 5 of the light box 4, while the legs form two parallel metal plates 25,26. Present between the two metal plates 25,26 is a block-shaped piece of a flexible, synthetic foam material 27, which is shown in perspective view in FIG. 9.

The piece of foam material 27 is provided with holes 28, through which the lamps 1 can extend, and with cuts 29 (only shown in FIGS. 8 and 9), thus making it possible to fit the lamps 1 after the piece of foam material 27 has been placed between the metal plates 25,26. FIG. 6 shows the wall 18 in side elevation, showing the recesses 30 in the plates 26 in which the lamps 1 are present. The dimension of said recesses 30 is larger than the diameter of the lamps 1, so that the lamps 1 do not touch the metal plates 26. The metal plate 25 is provided with corresponding recesses.

The diameter of the holes 28 is slightly smaller than that of the lamps 1, so that the foam material 27 abuts firmly against the glass of the lamps 1. Furthermore, the height of the block-shaped piece of for material 27 is greater than the height of the metal plates 25,26, so that the foam material 27 extends above the light box 4 (see FIGS. 2 and 3). As a result, the foam material 27 abuts firmly against the cover plates 15,16 in the fitted position of said cover plates in the light box 4. In this way a dustproof seal between the space 20 (the housing of the lamps 1) and the channel 21 and the space 22 has been obtained.

Because the space 20 is sealed dust-tight, impurities cannot enter the space, not even when air flows into or out of said space as a result of the temperature changes that occur within the space 20. This is important, in particular in order to keep the lamps 1 and the inner wall of the space 20, which is coated with a highly reflective material, free from impurities.

FIGS. 10 and 11 show the cover plates 15,16. Each cover plate 15,16 comprises an upper part 40, which part has an edge in which holes 41 are present. Said edge can be attached to the flange 10 of the light box 4, with the holes 41 corresponding to the holes 14. Each cover plate 15,16 comprises a part 42, which part extends perpendicularly to the upper part 40. Said part 42 is provided with recesses 43, through which the lamps 1 extend in the mounted position of the cover plate 15,16 in the light box 4. In that position, the part 42 of the cover plate 15 abuts against the metal plates 26 of the wall 18, and the part 42 of the cover plate 16 abuts against the metal plate 25 of the wall 19, as is shown in FIG. 5.

As FIG. 5 shows, the ends of each lamp 1 extend into the channel 21 on the one hand and into the space 22 on the other hand, which channel and which space are both sealed dust-tight from the space 20 in which the lamps 1 are present. As a result, the fittings 2 are not arranged in the space 20 that is present behind the crystal display matrix 13 (see FIG. 3), but outside said space, as is the cap 3 that is present on the end of the lamp 1. Only the part of the lamp 1 that provides a good light emission is present in the space 20, so that a good and even lighting of the crystal display matrix 13 is obtained.

Since the fittings 2 are not present in the housing of the lamps 1 (space 20), they can extend through the rear wall of the light box 4, without a dustproof seal being required at that location.

The so-called cold spot of the lamp, whose temperature must be kept within predetermined bounds in order to obtain a proper light output of the lamps 1, is present in the parts of the lamps 1 that extend through the wall 18 into the channel 21. Present within the cold spot is a space in which condensation of the mercury that is contained within the lamp takes place.

The air that flows through the channel 21 cools the ends of the lamp 1 extending into the channel 21. A sensor (not shown) measures the temperature of the end of one or more lamps and turns three fans 33 on or off in dependence on the measured temperature. Each of said fans 33 blows air into the channel 21 via holes 34 present between the ends of two lamps 1, whilst the air flows out of the channel 21 via two large holes 35 and two small holes 36 in the wall 9 of the light box 4. The holes 34,35,36 are shown in FIG. 7.

A suitable selection of the location of the holes 35,36 will result in the ends of the lamps 1 all being cooled to the same extent when the fans 33 are activated. The same obtains when the fans do not blow air into the channel 21 but extract air therefrom, so that air flows into the channel 21 through the holes 35,36.

The embodiment of a liquid crystal display as described above is merely an example; a great many other embodiments are possible.

1. A backlight device, in particular for a liquid crystal display, which comprises several lamps disposed within a housing, whereby each lamp comprises a part that can be cooled so as to obtain a good light output, characterized in that the aforesaid parts of the lamps extend through the wall of the housing into a channel through which air can flow.

2. A backlight device as claimed in claim 1, characterized in that said lamps are tube-like fluorescent lamps, which extend into the channel with at least one end.

3. A backlight device as claimed in claim 1, characterized by a fan for generating an air flow through the channel.

4. A backlight device as claimed in claim 3, characterized in that said fan extracts air from the channel, or blows air into the channel, as the case may be, at a location between two of the aforesaid lamp parts.

5. A backlight device as claimed in claim 1, characterized by sensor for measuring the temperature of the part of a lamp that extends into the channel.

6. A backlight device as claimed in claim 1, characterized in that the channel comprises a wall which is provided with a recess between two of the aforesaid lamp parts so as to allow air to pass therethrough.

7. A backlight device as claimed in claim 1, characterized in that the housing of the lamps forms a dustproof space, and in that the aforesaid wall abuts against the lamp in a substantially dust-tight manner at the location where the lamp extends through said wall.

8. A backlight device as claimed in claim 7, characterized in that said wall comprises a flexible material, which abuts against the lamp.

9. A backlight device as claimed in claim 1, characterized in that the housing abuts against a diffuser plate in a dust-tight manner.

10. A liquid crystal display comprising a backlight device as claimed in claim 1.

11. A method of lighting a liquid crystal display, which display includes a backlight device which comprises several lamps disposed within a housing, whereby each lamp comprises a part that can be cooled so as to obtain a good light output, characterized in that the aforesaid parts of the lamps extend through the wall of the housing into a channel through which air flows.
